(19) United States
(12) Patent Application Publication
(10) Pub. No.: US 2005/0266824 A1
(43) Pub. Date: Dec. 1, 2005

(54) Direction assistance by telephone

(76) Inventor: Carolyn Margaret Price, Scottdale, PA (US)

Correspondence Address: CAROLYN MARGARET PRICE, 111 BROAD STREET, SCOTTDALE, PA, 15683, US

(21) Appl. No.: 10/918,789

(22) Filed: Aug. 16, 2004

Related U.S. Application Data
(60) Provisional application No. 60/575,514, filed on Jun. 1, 2004.

(51) Int. Cl. H04Q 7/20

(52) U.S. Cl. 455/403

(57) ABSTRACT

Our customers may utilize our service whenever they need direction assistance for any reason, and our service will be offered as a fee-based and non-fee-based service. Our customers will contact us by telephone and provide us with a location and/or destination. Live customer service representatives will answer the telephone calls and provide direction assistance. Our service will be provided by accessing paper maps, computer software, electronic instrumentation, and, in some instances, first-hand knowledge about road conditions, detours, construction sites/routes, alternate routes, landmarks and rarely used avenues. This information will be provided to our customer service representatives by scouts/runners who will canvas streets and highways to gather the most current information in order to provide accurate information to our customers.

This claim is referenced in Disclosure Document No. 554342 and Application No. 60/575,514 and Confirmation No. 2939.

### CROSS-REFERENCE TO RELATED APPLICATIONS

This claim is referenced in Disclosure Document No. 554342 and Application No. 60/575,514 and Confirmation No. 2939.

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

My being lost too many times, and my imagination.

### BRIEF SUMMARY OF THE INVENTION

Direction assistance by telephone

### BRIEF DESCRIPTION OF THE SEVERAL VIEWS OF THE DRAWING

N/A

### DETAILED DESCRIPTION OF THE INVENTION

Direction (Map)Assistance By Telephone—land telephone and/or cell phone. Direction assistance by telephone means the initial communication for direction assistance will be by telephone. When a customer needs directions because they are lost or trying to determine their direction or a specific destination, if they have access to a telephone they are able to call our business and request direction assistance.

This service will be offered by live customer service representatives who will utilize paper maps, computer software, specialized/customized/designed computer map programs, satellite and electronic instrumentation, government and non-government map/zoning office materials provided for public use.

This service will be offered in different languages and to the hearing and visually impaired consumer.

This service will be marketed using various Trademarks: Voice Map, Phone Map, Live Map, and Direction Assistance. Our slogan will be “I'll never be lost again.” This service will be marketed as a fee-based and non-fee-based service, in particular circumstances to be determined by the inventor.

1. What I claim as my invention is the idea to offer direction assistance by telephone using live customer service representatives. Our customers do not have to join a club or purchase satellite or navigation equipment or gadgets. All they need is a ground telephone or cell phone.
For discovery and marketability purposes I visited New York, New Jersey, D.C., Chicago, Atlanta, and Pittsburgh, and this service is not offered. There is a huge marketplace for this service. It will be offered nationwide, 24/7, as a fee based and, in particular circumstances, non-fee-based service.
People are lost all the time, whether they are driving or walking, and they can only ask strangers for directions and hope they get the right directions. By calling Voice Map, Phone Map, or Live Map (our Trademarks) they can eliminate this problem and get accurate directions. Our slogan will be “I'll never be lost again.”
This claim is referenced in Disclosure Document No. 554342 and Application No. 60/575,514 and Confirmation No. 2939.
